(19) United States
(12) Patent Application Publication
(10) Pub. No.: US 2005/0037185 A1
(43) Pub. Date: Feb. 17, 2005

(54) Glazing for vehicles

(76) Inventors: Joseph Dierckx, Jumet (BE); Gunther Heraly, Jumet (BE); Christophe Meerman, Jumet (FR)

Correspondence Address: Piper Rudnick;Patent Prosecution Services, 1200 Nineteenth Street NW, Washington, DC, 20036-2412, US

(21) Appl. No.: 10/343,658

(22) PCT Filed: Feb. 15, 2002
(86) PCT No.: PCT/EP02/01696

(30) Foreign Application Priority Data
Mar. 6, 2001 (BE) 2001/0147

(51) Int. Cl. B32B 7/02

(52) U.S. Cl. 428/216

(57) ABSTRACT

The invention relates to laminated glazing for vehicles having a limited energy transmittance. According to the invention, the glazing has a light transmittance of at least 70%, an energy transmittance TE that is at most equal to 51% and, for thicknesses requested by manufacturers, thicknesses for which Texe, wherein e is the total thickness of the sheets of glass in millimetres, is at most equal to 200. The inventive glazing provides a balanced solution that satisfies demands in terms of cost and sun-protection properties for vehicles, particularly motor vehicles.

The present invention relates to laminated glazing for vehicles. In particular, the invention relates to laminated glazing having a limited energy transmittance.

There is an increasing demand from automobile manufacturers for glazing which serves several functions. For example, in the case of side windows of an automobile, these should contribute towards the comfort and security of the vehicle. With respect to comfort, this means in particular contributing to improving the temperature inside the passenger compartment when the vehicle is exposed to the sun. It also means improving, where necessary, the sound level of the passenger compartment. With respect to security, the requirement is primarily to reinforce mechanical resistance to forced entry.

While solutions to these requirements are conceivable in principle, their industrial application raises numerous problems. The greatest difficulty is to meet envisaged cost levels that manufacturers are willing to accept.

Working from the idea that an improvement in security is obtained by using laminated glazing, it must be established under what conditions such glazing enables the other desired characteristics to be achieved, in particular the cost conditions. It is self-evident that whatever the qualities of such glazing, it is important to remain within the most limited cost conditions possible.

Hence, various solutions are known for providing glazing with sun-protection properties. In the case of monolithic glazing, the most usual solution is to use coloured glasses. In the case of laminated glazing, in addition to using coloured glasses, it is possible to include elements in the intermediate layer such as thin films coated with thin reflective layers, or also to deposit these same layers directly onto the surfaces of the sheets not exposed to external or internal stresses.

The use of layers deposited on the glass or on a film incorporated as interlayer has the advantage of providing a good sun-protection effect by means of energy reflection. In addition, the low energy transmittance resulting from this is obtained without the light transmission (TL) necessarily being reduced too significantly. It must in fact be remembered that side windows of an automobile are subject to strict standards, e.g. a light transmission of at least 70% for the front of the vehicle.

In spite of the advantages outlined above, the cost of solutions involving sun-protection layers is a factor which restricts the development of glazing of this type.

The inventors have therefore proposed to develop laminated glazing for automobiles by endeavouring to meet the requirements outlined above. Moreover, the requirement relating to thickness must also be included with these requirements.

Automobile manufacturers want to be able to offer their customers the choice between “traditional” monolithic glazing units “as standard” or laminated glazing units with the functions in question “as optional extra” to take into account differences in cost corresponding to these two types of installations. At the same time, the manufacturers require that the two types of glazing are usable without any modification of the elements on which these glazing units are assembled. The frames, slides etc. must be usable equally with monolithic glazing and laminated glazing. This requires that these two types of glazing are of absolutely equal thickness, or if not at least differ very little in thickness.

The inventors have managed to combine these two different requirements and propose laminated glazing for automobiles comprising two sheets of coloured glass, of which the light transmission (TL) for the thicknesses required by manufacturers is at least equal to 70%, the energy transmittance (TE) is at most 51%, and this for a glass thickness such that the product TExe, wherein TE is expressed as a percentage and e is the total thickness of the two glass sheets expressed in millimetres, remains at most equal to 200. This expression conveys the constraints in which the glazings according to the invention are subject to.

The rigorous conditions the glazing in question must meet are achieved partly as a result of the colourations required. It is relatively more difficult to achieve these conditions with glasses with a blue colouration. With these glasses the difficulty lies in lowering the energy transmittance to sufficiently low levels without the light transmission becoming too low at the same time. For this reason, the term TExe only varies within a limited range. Nevertheless, the blue glazing types according to the invention are preferably such that TExe is less than 195.

TExe can be more easily limited with green glazing. This value can be brought to values equal to 180 at most without too much difficulty.

The thickness of the glazing is preferably in the range of between 3.5 and 5.5 mm. Most usually, the glazing according to the invention has a total thickness in the range of between 3.8 and 5 mm.

Moreover, the use of two distinct glasses has the disadvantage for the manufacturer of having to hold increased stocks. Therefore, it is preferable to assemble glass sheets of the same composition. For the same reasons, it is preferable to combine two glasses with identical thicknesses rather than glasses with different thicknesses.

In the following description as well as in the claims, the TL used is that determined using the standard illuminant A as defined by the Commission Internationale de l'Éclairage. Illuminant A represents the radiation of a Planck radiator at a temperature of about 2856 K. This illuminant constitutes the light emitted by vehicle headlights and is essentially intended for evaluation of the optical properties of glazing intended for motor vehicles. TL and TE are:
the total light transmission with illuminant A (TLA): this total transmission is the result of integration between the wavelengths of 380 and 780 nm of the term: ΣT_{λ}.E_{λ}.S_{λ}/ΣE_{λ}.S_{λ}, in which T_{λ} is the transmission at wavelength λ, E_{λ} is the spectral distribution of illuminant A and S_{λ} is the sensitivity of the normal human eye as a function of wavelength λ;
the total energy transmittance (TE): this total transmittance is the result of integration between the wavelengths of 300 and 2500 nm of the term: ΣT_{λ}.E_{λ}/ΣE_{λ}, wherein E_{λ} is the spectral energy distribution of the sun at 30° above the horizon.

Colours likewise come into the choice of glasses. They are important in the production of the glasses in question. They are equally important in the definition of the properties of transmission in visible, infrared or ultraviolet light, these properties by definition determining the use according to the invention. Moreover, the choice of colours must meet the aesthetic appeal sought by manufacturers. In practice, the glazing must have a predominantly green or blue colouration.

The glasses used according to the invention match the traditional basic soda-lime compositions, in which the main components have the following proportions by weight:

| | | | |
|---|---|---|---|
| SiO₂ | 60-75% | Na₂O | 10-20% |
| CaO | 0-16% | K₂O | 0-10% |
| MgO | 0-10% | Al₂O₃ | 0-5% |
| BaO | 0-2% | | |

with

| | |
|---|---|
| K₂O + Na₂O | 10-20% |
| CaO + MgO + BaO | 10-20%. |

In addition to the soda-lime base, the glasses used according to the invention comprise the following colouring agents, and primarily iron oxides. These colouring agents are contained in the following general proportions:

| | |
|---|---|
| Fe₂O₃ (total iron expressed as) | 0.5-1% |
| FeO | 0.14-0.25% |
| Co | 0-0.0040% |
| Cr₂O₃ | 0-0.0500% |
| Vr₂O₅ | 0-0.0200% |
| Se | 0-0.0050%. |

The compositions may also contain other colouring agents, in particular those resulting from the raw materials used, in proportions by weight not exceeding the following:
TiO₂<0.1%
MnO₂<0.13%
CeO₂<0.5%.

Preferred compositions correspond to a combination of colouring agents such as the following:

| | |
|---|---|
| Fe₂O₃ (total iron expressed as) | 0.5-0.7% |
| FeO | 0.16-0.22% |
| Co | 0-0.0020% |
| Cr₂O₃ | 0.0020-0.0045%. |

Even more precisely, glasses with a predominantly blue colouration preferably correspond to the following compositions of colouring agents with the glazing according to the invention:

| | |
|---|---|
| Fe₂O₃ (total iron expressed as) | 0.5-0.6% |
| FeO | 0.16-0.20% |
| Co | 0-0.0020% |
| Cr₂O₃ | 0.0020-0.0045%. |

Other compositions of colouring agents in the case of the glazing according to the invention with a predominantly green colouration are advantageously as follows:

| | |
|---|---|
| Fe₂O₃ (total iron expressed as) | 0.7-1% |
| FeO | 0.18-0.25% |
| Co | 0-0.0040% |
| Cr₂O₃ | 0-0.0250% |
| V₂O₅ | 0-0.0200%. |

In a preferred manner, predominantly green glazing types comprise glasses with the following colouring agents:

| | |
|---|---|
| Fe₂O₃ (total iron expressed as) | 0.7-1% |
| FeO | 0.18-0.24% |
| V₂O₅ | 0-0.0200%. |

Glazing types exhibiting the characteristics of the invention have been formed by way of an example. In these examples all the glazing types are laminated with an interlayer of clear polyvinyl butyral with a thickness of 0.76 mm.

The glasses of the formed assemblies have a soda-lime base with the following proportions by weight:

| | | | |
|---|---|---|---|
| SiO₂ | 71.5-71.9% | Na₂O | 14.1% |
| CaO | 8.8% | K₂O | 0.1% |
| MgO | 4.2% | Al₂O₃ | 0-8%. |

In these glasses the colouring agents are respectively present in the following proportions by weight:

| | I | II | III | IV | V | VI |
|---|---|---|---|---|---|---|
| Fe₂O₃ | 0.08 | 0.84 | 0.95 | 0.63 | 0.38 | 0.57 |
| FeO | 0.01 | 0.21 | 0.24 | 0.15 | 0.12 | 0.18 |
| Co | | | | | 0.0012 | 0.0014 |
| Cr₂O₃ | | | | | | 0.0041 |
| V₂O₅ | | | 0.0150 | | | |

The glazing units are formed in different thicknesses. The two sheets have the same thickness in all the examples. Two series are formed for glazing units with a green hue, their total thickness being close to 4 mm and 5 mm respectively.

The first series is that with a thickness of about 5 mm. The characteristics of the glazing units are indicated in the following table:

| | Glass 1 | Glass 2 | Total thickness | TL % | TE % | TExe |
|---|---|---|---|---|---|---|
| 1 | IV | IV | 4.96 | 76.1 | 50.4 | 212 |
| 2 | III | I | 4.96 | 75.3 | 52.6 | 221 |
| 3 | II | IV | 4.96 | 72.8 | 45.5 | 191 |
| 4 | II | II | 4.96 | 69.8 | 42.1 | 177 |
| 5 | III | IV | 4.96 | 69.7 | 42.8 | 180 |

In the tests reported above, it may be seen that with thicknesses close to 5 mm, the conditions sought according to the invention are only strictly met in example 3. Examples 1 and 2 have a TE which is too high and also a TExe value that is too high. Conversely, examples 4 and 5 have a TL that is slightly less than standard.

In the case of the combinations of types 1 and 2, a slight increase in thickness of the glass sheets allow the TE to be brought into the ranges of the invention. However, at the same time the thicknesses, and therefore the term TExe, increase further. This shows how difficult it is to attain all the fixed conditions.

Conversely, in the case of combinations 4 and 5, the TE is satisfactory and the light transmission is very slightly less than the standard for these glazing types. A slight decrease in thickness allows the TL to be brought to above 70%. Hence, in example 4 a variation in thickness of each sheet from 2.1 to is 2.0 mm results in values for the TL of 71.6% and for the TE 43.8%, which are completely adequate. The value of the TExe also remains in the limits fixed according to the invention. With respect to example 3 this structure has the additional advantage of combining two glass sheets that are identical and are therefore more readily matched after bending.

The second series of glazing units has a smaller thickness of little more than 4 mm. In this series the thickness of each sheet is 1.7 mm. As above, the interlayer has a thickness of 0.76 mm. The resulting measurements are given in the following table:

| | Glass 1 | Glass 2 | Total thickness | TL % | TE % | TExe |
|---|---|---|---|---|---|---|
| 6 | II | II | 4.16 | 73.4 | 46.5 | 158 |
| 7 | III | IV | 4.16 | 73.3 | 48.1 | 164 |
| 8 | III | II | 4.16 | 70.8 | 44.3 | 151 |
| 9 | III | III | 4.16 | 68.6 | 40.7 | 139 |

In these different examples only 9 does not meet the condition with respect to the TL. As previously, a slight decrease in thickness allows the TL to be brought to above the imposed limit. Of the other examples, 6 is of particular interest, since it allows two identical sheets to be combined.

Similar tests to the above have been conducted with glasses with a blue hue, also with total thicknesses close to 5 and 4.5 mm. These assemblies were formed with two sheets of the same thickness of 2.1 mm, 1.9 mm, 1.85 mm or 1.7 mm.

The characteristics of the glazing types produced are shown in the following table:

| | Glass 1 | Glass 2 | Total thickness | TL % | TE % | TExe |
|---|---|---|---|---|---|---|
| 10 | VI | V | 4.96 | 73.0 | 49.7 | 209 |
| 11 | VI | VI | 4.56 | 72.0 | 48.1 | 183 |
| 12 | VI | VI | 4.46 | 72.4 | 48.7 | 180 |
| 13 | VI | VI | 4.16 | 73.4 | 50.8 | 173 |

Examples 11, 12 and 13 meet the various conditions demanded of glazing according to the invention. Example 10 has too high a TExe value, even though the TE is acceptable. This type of assembly shows the difficulty of attaining all the required conditions. In fact, a reduction in thickness of each of the sheets would result in an increase in the TE and therefore lead to an unsatisfactory glazing.

1. Laminated glazing for vehicles comprising two sheets of coloured glass, of which the light transmission (TL) for the thicknesses required by manufacturers is at least equal to 70%, the energy transmittance (TE) is at most equal to 51% and the term TExe, wherein TE is expressed as a percentage and e is the total thickness of the two glass sheets expressed in millimetres, is at most equal to 200.

2. Laminated glazing according to claim 1, wherein the energy transmittance is at most equal to 48%.

3. (Canceled)

4. (Canceled)

5.

6. (Canceled)

7. (Canceled)

8. (Canceled)

9. (Canceled)

10. (Canceled)

11. (Canceled)

12. Laminated glazing according to claim 1, and further including at least one of the following (A) through (D):
A. wherein the total thickness of the two glass sheets is in the range of between 3.5 and 5.5 mm;
B. wherein the two glass sheets have the same glass composition;
C. wherein the glass sheets have the same thickness;
D. wherein the glass sheets the following soda-lime composition:

| | | | |
|---|---|---|---|
| SiO₂ | 60-75% | Na₂O | 10-20% |
| CaO | 0-16% | K₂O | 0-10% |
| MgO | 0-10% | Al₂O₃ | 0-5% |
| BaO | 0-2% | | |

with

| | |
|---|---|
| K₂O + Na₂O | 10-20% |
| CaO + MgO + BaO | 10-20% |

and comprising the following main colouring agents:

| | |
|---|---|
| Fe₂O₃ (total iron expressed as) | 0.5-1% |
| FeO | 0.14-0.25% |
| Co | 0-0.0040% |
| Cr₂O₃ | 0-0.0500% |
| Vr₂O₅ | 0-0.0200% |
| Se | 0-0.0050%. |

13. Laminated glazing according to claim 12, and including at least two of the features (A) through (D).

14. Laminated glazing according to claim 12, and including all of the features (A) through (D).

15. Laminated glazing according to claim 1, wherein the total thickness of the two glass sheets is in the range of between 3.8 and 5.2 mm.

16. Laminated glazing according to claim 1, for which the term TExe is at most equal to 195.

17. Laminated glazing according to claim 1, wherein the soda-lime composition of the glass sheets comprises the following colouring agents:

| | |
|---|---|
| Fe₂O₃ (total iron expressed as) | 0.5-0.6% |
| FeO | 0.16-0.20% |
| Co | 0-0.0020% |
| Cr₂O₃ | 0.0020-0.0045%. |

18. Laminated glazing according to claim 1, wherein the soda-lime composition of the glass sheets comprises the following colouring agents:

| | |
|---|---|
| Fe₂O₃ (total iron expressed as) | 0.7-1% |
| FeO | 0.18-0.24% |
| V₂O₅ | 0-0.0200%. |
